(19) United States
(12) Patent Application Publication
(10) Pub. No.: US 2017/0051466 A1
(43) Pub. Date: Feb. 23, 2017

(54) APPARATUS HAVING A ROLLING VEHICLE FOR USE WITH OIL SLICK

(71) Applicant: Garrett Shawn WRUTH, Sexsmith (CA)

(72) Inventor: Garrett Shawn WRUTH, Sexsmith (CA)

(21) Appl. No.: 14/828,897

(22) Filed: Aug. 18, 2015

(51) Int. Cl. E02B 15/10; B66C 1/10; E02B 15/04; B62D 39/00

(52) U.S. Cl. CPC E02B 15/103; B62D 39/00; B66C 1/10; E02B 15/045

(57) ABSTRACT

The apparatus is for use with an oil slick. The apparatus includes a rolling vehicle having a vehicle frame; a lift system supported by the vehicle frame; a hydraulic-control system supported by the vehicle frame; an oil-holding tank system supported by the vehicle frame, and an oil-slick skimmer system configured to be lifted and moved by the lift system onto the oil slick.

### TECHNICAL FIELD

This document relates to the technical field of (and is not limited to) an apparatus for use with an oil slick, in which the apparatus includes a rolling vehicle, a lift system, a hydraulic-control system, an oil-holding tank system and an oil-slick skimmer system.

### BACKGROUND

The advent of onshore (land) oil-drilling platforms, oil-processing facilities, etc., the use of oil-transporting pipelines and/or oil-transporting railway cars to transport petroleum-based product (such as, crude oil, oil and the like, and any equivalent thereof) have increased the likelihood of oil spills on land, which at times leads to unwanted oil spills into a body of water (lake, wetland, etc.) located proximate to the oil spill. The damage and destruction to the water (as a result of the oil spill) wreaks havoc to water and the local environment.

### SUMMARY

It will be appreciated that there exists a need to mitigate (at least in part) at least one problem associated with the existing oil-spill removal systems (also called the existing technology) for cleaning up oil spills on land and from a body of water surrounded by land. After much study of the known systems and methods with experimentation, an understanding of the problem and its solution has been identified and is articulated as follows:

Current methods of cleaning polluted waters have been unsatisfactory, particularly when the conditions have been less than ideal. Speed in cleaning spills is critical. Delays may occur in cleaning isolated sites due to problems in transporting the equipment to the site.

What is needed is a system for removing oil spills from the affected body of water.

To mitigate, at least in part, at least one problem associated with the existing technology, there is provided (in accordance with a major aspect) an apparatus. The apparatus is for use with an oil slick suspended in a body of water. The apparatus includes a rolling vehicle. The rolling vehicle includes a vehicle frame, a lift system is supported by the vehicle frame; and a hydraulic-control system supported by the vehicle frame; an oil-holding tank system supported by the vehicle frame (the oil-holding tank system is also configured to receive a portion of the oil slick, with the oil-holding tank system configured to apply suction for moving the oil slick into the oil-holding tank system); and an oil-slick skimmer system. The oil-slick skimmer system is configured to: (A) be supported by the vehicle frame; (B) be in fluid communication with the oil-holding tank system; (C) be lifted and moved by the lift system onto the oil slick suspended in the body of water; and (D) be operated by the hydraulic-control system in such a way that the hydraulic-control system, in use, urges the oil-slick skimmer system to pick up the oil slick suspended in the body of water, and the oil-holding tank system moves the oil slick from the oil-slick skimmer system into the oil-holding tank system.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1A and FIG. 1B (SHEETS 1 AND 2 OF 6 SHEETS) depict side views of embodiments of an apparatus for use with an oil slick suspended in a body of water;

FIG. 2 (SHEET 3 OF 6 SHEETS) depicts a perspective view of an embodiment of an oil-slick skimmer system of the apparatus of FIG. 1A;

FIG. 3 (SHEET 4 OF 6 SHEETS) depicts an end view of an embodiment of the oil-slick skimmer system of FIG. 2;

FIG. 4 (SHEET 4 OF 6 SHEETS) depicts a side view of an embodiment of the oil-slick skimmer system of FIG. 2;

FIG. 5 (SHEET 5 OF 6 SHEETS) depicts a top view of an embodiment of the oil-slick skimmer system of FIG. 2; and

FIG. 6A and FIG. 6B (SHEET 6 OF 6 SHEETS) depict side views of embodiments of the oil-slick skimmer system of FIG. 2.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 buoyant frame assembly
104 lift connection
106 elongated rotatable drum assembly
108 hydraulic motor
110 wiper assembly
112 outer elongated surface
114 oil-collection container
116 connection tube
118 coupler
120 soaker pad assembly
122 spaced-apart pontoon hulls
900 oil slick
902 water
904 rolling vehicle
905 wheels
906 vehicle frame
908 lift system
910 hydraulic-control system
912 oil-holding tank system
914 oil-slick skimmer system
916 truck
918 trailer
920 hitch connection
922 truck frame
924 trailer frame
926 oil-conveying line
928 control line
930 hydraulic control
932 suction pump
934 main hydraulic motor
936 washing station

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

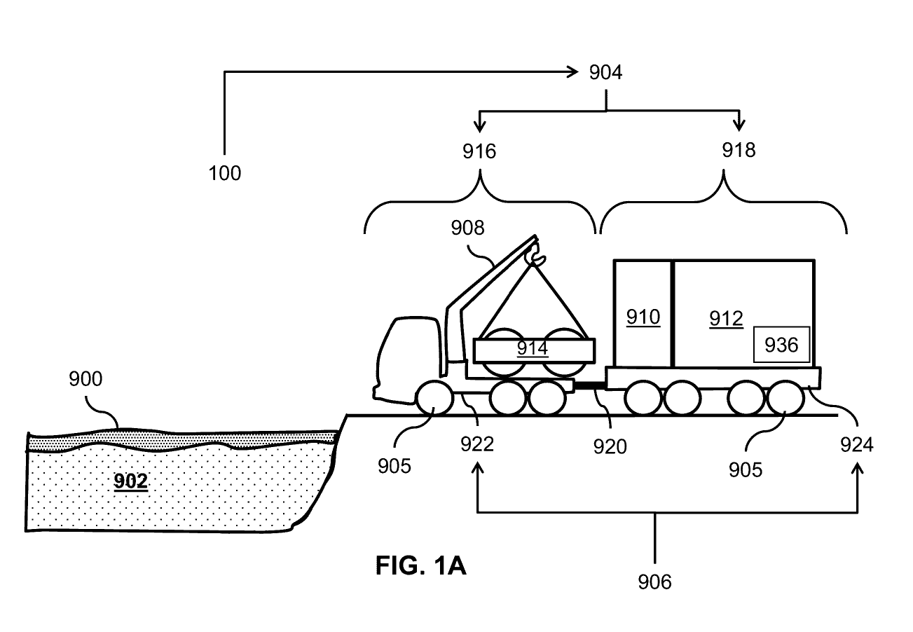

FIG. 1A and FIG. 1B depict side views of embodiments of an apparatus 100 for use with an oil slick 900 suspended in a body of water 902.

The oil slick 900 may include any type of petroleum-based product.

The apparatus 100 includes (and is not limited to) a rolling vehicle 904. The rolling vehicle 904 includes (and is not limited to) a synergistic combination of a vehicle frame 906, a lift system 908, a hydraulic-control system 910, an oil-holding tank system 912 and an oil-slick skimmer system 914.

A rolling vehicle 904 includes wheels 905 (rotatable wheels) configured to roll (in use). In accordance with a specific embodiment (option), the rolling vehicle 904 includes a truck 916 with a trailer 918. The trailer 918 is operatively attached to the truck 916 with a hitch connection 920. The vehicle frame 906 includes a truck frame 922 and a trailer frame 924. For this case, the lift system 908, the hydraulic-control system 910, the oil-holding tank system 912 and the oil-slick skimmer system 914 are positioned and supported by the combination of the truck frame 922 and the trailer frame 924. The arrangement of the lift system 908, the hydraulic-control system 910, the oil-holding tank system 912 and the oil-slick skimmer system 914 on the truck frame 922 and the trailer frame 924 is not critical.

In accordance with an embodiment, the rolling vehicle 904 includes the vehicle frame 906, the lift system 908, the hydraulic-control system 910, the oil-holding tank system 912 and the oil-slick skimmer system 914 on the vehicle frame 906 are arranged on (mounted to) the vehicle frame 906 (in any suitable arrangement).

The lift system 908 (also called a boom) is supported by the vehicle frame 906. More specifically, the lift system 908 is supported by the truck frame 922. The lift system 908 is motorized (electrically or hydraulically motorized).

The hydraulic-control system 910 is supported by the vehicle frame 906. More specifically, the hydraulic-control system 910 is supported by the trailer frame 924. It is preferred to use the hydraulic-control system 910 (preferably for hydraulic control as opposed to electrical control) in order to reduce (preferably eliminate) the possibility of explosion associated with retrieving the oil slick 900 from the body of water 902.

The oil-holding tank system 912 is supported by the vehicle frame 906. The oil-holding tank system 912 is also configured to receive a portion of the oil slick 900. In addition, the oil-holding tank system 912 is configured to apply suction (vacuum) where (in which) the suction (a vacuum) is used to draw (move) the oil slick 900 into the oil-holding tank system 912. More specifically, the oil-holding tank system 912 is supported by the trailer frame 924. The oil-holding tank system 912 is positioned adjacent to the hydraulic-control system 910 on the trailer frame 924. For instance, a transfer pump (known and not depicted) may be used to transfer (in use) the oil slick to the oil-holding tank system 912.

The oil-slick skimmer system 914 is configured to be supported by the vehicle frame 906. The oil-slick skimmer system 914 is also configured to be in fluid communication with the oil-holding tank system 912 (once connected to do just so by an oil-conveying line 926). The oil-slick skimmer system 914 is also configured to be lifted and moved by the lift system 908 onto the oil slick 900 suspended in the body of water 902. For instance, the oil-slick skimmer system 914 includes lines (chains) configured to attach to the lift system 908. The oil-slick skimmer system 914 is also configured to be operated by the hydraulic-control system 910. The oil-slick skimmer system 914 is also configured to be in fluid communication with the hydraulic-control system 910 (once connected to do just so by a control line 928 to do just so). This is done in such a way that the hydraulic-control system 910, in use, urges the oil-slick skimmer system 914 to pick up the oil slick 900 suspended in the body of water 902, and the oil-holding tank system 912 moves the oil slick 900 from the oil-slick skimmer system 914 into the oil-holding tank system 912.

As a result, the oil-holding tank system 912, in use, receives a portion of the oil slick 900 from the oil-slick skimmer system 914 once (A) the oil-slick skimmer system 914 is moved onto the oil slick 900 suspended in the body of water 902, and (B) the oil-slick skimmer system 914 is in fluid communication with the oil-holding tank system 912, and (C) the hydraulic-control system 910 and the oil-holding tank system 912 are activated just so.

In accordance with an embodiment, the oil-slick skimmer system 914 includes a compact portable floating skimmer that is configured to remove the oil slick 900 floating on the body of water 902. The body of water 902 may include an oil field or wetlands. The oil-slick skimmer system 914 is configured to remove the oil slick 900 from the top of the body of water 902. The oil-slick skimmer system 914 is configured to (A) rotate on the top of the body of water 902, and (B) transfer the oil slick 900 via a pump and hoses to the oil-holding tank system 912 (for later removal and/or transfer to a disposal facility). In this manner, the body of water 902 may be relatively cleaner once the oil slick 900 is removed (at least in part) from the body of water 902.

More specifically, the oil-slick skimmer system 914 is configured to (A) float on top of the body of water 902, and (B) rotate to, in effect, lick off the oil slick 900 from the top of the body of water 902. The oil-slick skimmer system 914 may be used (for instance, on wet lands) to remove soil spills and to mitigate (at least in part) the negative environmental impacts caused by the oil slick 900 (preferably by removing the oil slick 900).

In accordance with an option, the rolling vehicle 904 also includes a washing station 936, for washing down the systems of the rolling vehicle 904.

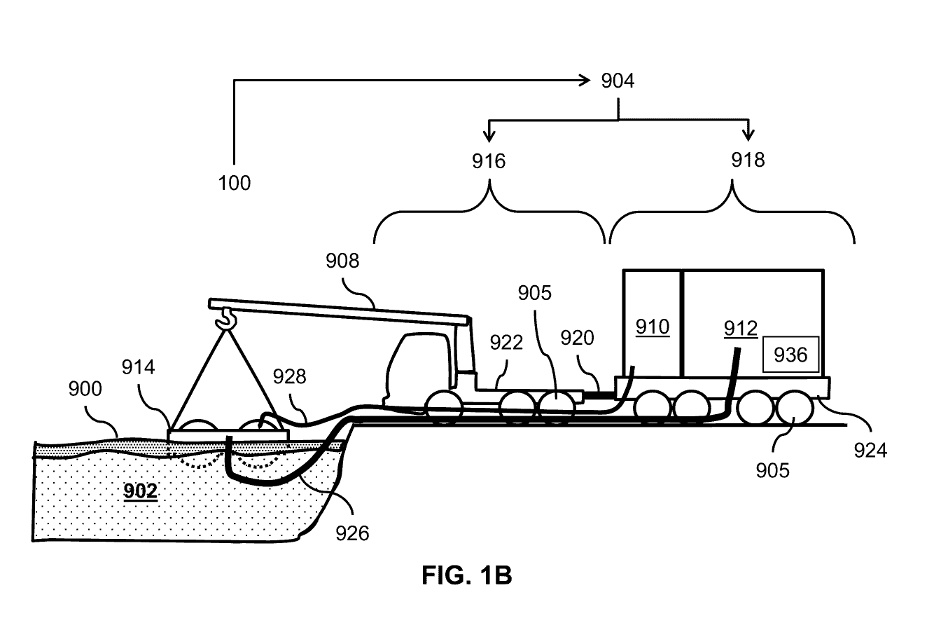

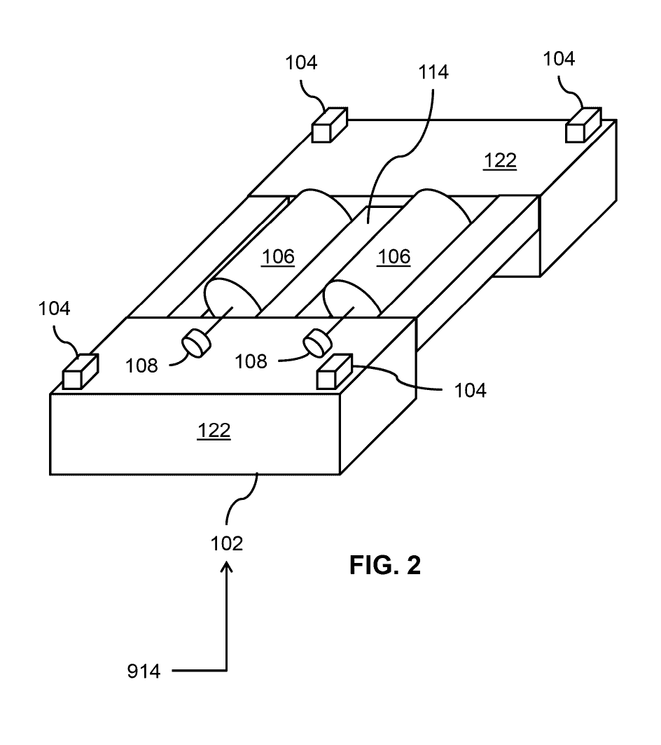

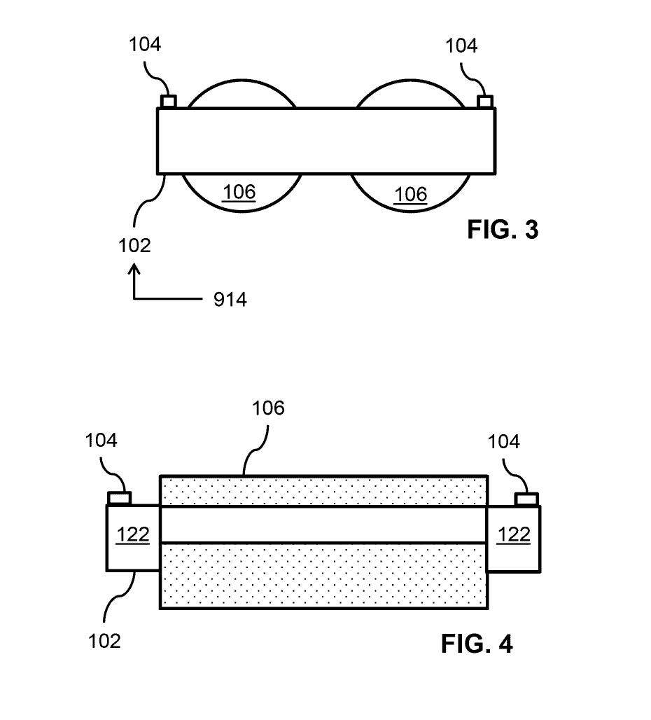

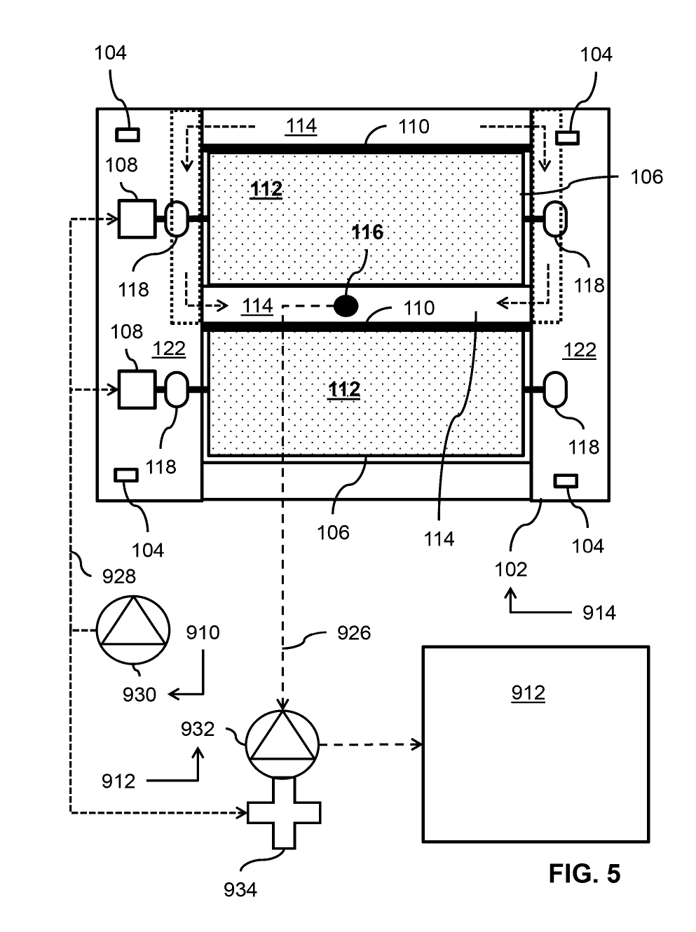

FIG. 2, FIG. 3, FIG. 4 and FIG. 5 depict a perspective view, an end view, a side view and a top view (respectively) of embodiments of the oil-slick skimmer system 914 of the apparatus 100 of FIG. 1A.

In accordance with the embodiment as depicted in FIG. 2, FIG. 3, FIG. 4 and FIG. 5, the apparatus 100 is adapted in such a way that the oil-slick skimmer system 914 includes a synergistic combination of a buoyant frame assembly 102, an elongated rotatable drum assembly 106, a hydraulic motor 108, a wiper assembly 110, an oil-collection container 114 and a connection tube 116.

The buoyant frame assembly 102 having a lift connection 104 is configured to be connected to the lift system 908. This is done in such a way that the lift system 908, in use, lifts the buoyant frame assembly 102.

The buoyant frame assembly 102 is configured to be buoyantly positioned in the oil slick 900 suspended in the body of water 902 once the buoyant frame assembly 102 is positioned by the lift system 908 to do just so.

The elongated rotatable drum assembly 106 is rotatably supported by the buoyant frame assembly 102. This is done in such a way that rotation of the elongated rotatable drum assembly 106, in use, contacts the oil slick 900 suspended on the body of water 902 (once the buoyant frame assembly 102 is buoyantly positioned in the oil slick 900 suspended in the body of water 902).

The hydraulic motor 108 is operatively connected to a rotation axis of the elongated rotatable drum assembly 106. The hydraulic motor 108 is configured for fluid connection with the hydraulic-control system 910. This is done in such a way that the hydraulic-control system 910, in use, drives the hydraulic motor 108, and the hydraulic motor 108, in use, urges rotation of the elongated rotatable drum assembly 106 (in response to activation of the hydraulic motor 108). Rotation of the elongated rotatable drum assembly 106, in use, urges the elongated rotatable drum assembly 106 to pick up the oil slick 900 from the body of water 902 once the buoyant frame assembly 102 is buoyantly positioned in the oil slick 900 suspended in the body of water 902.

Referring to the embodiment as depicted in FIG. 5, the wiper assembly 110 is supported by the buoyant frame assembly 102. The wiper assembly 110 extends toward an outer elongated surface 112 of the elongated rotatable drum assembly 106. This is done in such a way that the wiper assembly 110, in use, wipes the oil slick 900 from the outer elongated surface 112 of the elongated rotatable drum assembly 106 (once the hydraulic motor 108, in use, urges rotation of the elongated rotatable drum assembly 106 in response to activation of the hydraulic motor 108).

Referring to the embodiment as depicted in FIG. 5, the oil-collection container 114 is supported by the buoyant frame assembly 102. The oil-collection container 114 is configured to receive the oil slick 900 that is removed by the wiper assembly 110. The wiper assembly 110 (also called a scraper blade) is mounted across the sidebars, and is in contact with the elongated rotatable drum assembly 106. The wiper assembly 110 is set to bear against the elongated rotatable drum assembly 106 to separate the oil from the elongated rotatable drum assembly 106 and direct the oil into the oil-collection container 114.

Referring to the embodiment as depicted in FIG. 5, the connection tube 116 is configured to fluidly connect the oil-collection container 114 to the oil-holding tank system 912. This is done in such a way that the oil slick 900 moves from the oil-collection container 114 via the connection tube 116 to the oil-holding tank system 912 in response to the application of the oil-moving suction (oil pumping action) to the connection tube 116.

Referring to the embodiment as depicted in FIG. 5, the oil-slick skimmer system 914 includes a coupler 118 (a bearing device) that connects the hydraulic motor 108 to the rotatable shaft of the elongated rotatable drum assembly 106. The coupler 118 also supports the weight of the elongated rotatable drum assembly 106 as the elongated rotatable drum assembly 106 is made to rotate.

Referring to the embodiment as depicted in FIG. 5, the hydraulic-control system 910 (as depicted in FIG. 1A) includes a hydraulic control 930 configured to be fluidly connected to the hydraulic motor 108 (via the control line 928). The hydraulic control 930 is also configured to operate the hydraulic motor 108 (with a hydraulic fluid). This is done in such a way that the hydraulic motor 108 may rotate the elongated rotatable drum assembly 106.

Referring to the embodiment as depicted in FIG. 5, the oil-holding tank system 912 (as depicted in FIG. 1A) includes a suction pump 932 driven by a main hydraulic motor 934. The main hydraulic motor 934 is operated by the hydraulic control 930. The main hydraulic motor 934 drives the suction pump 932. The suction pump 932 pumps the oil slick 900 from the oil-collection container 114 of the oil-slick skimmer system 914 to the oil-holding tank system 912.

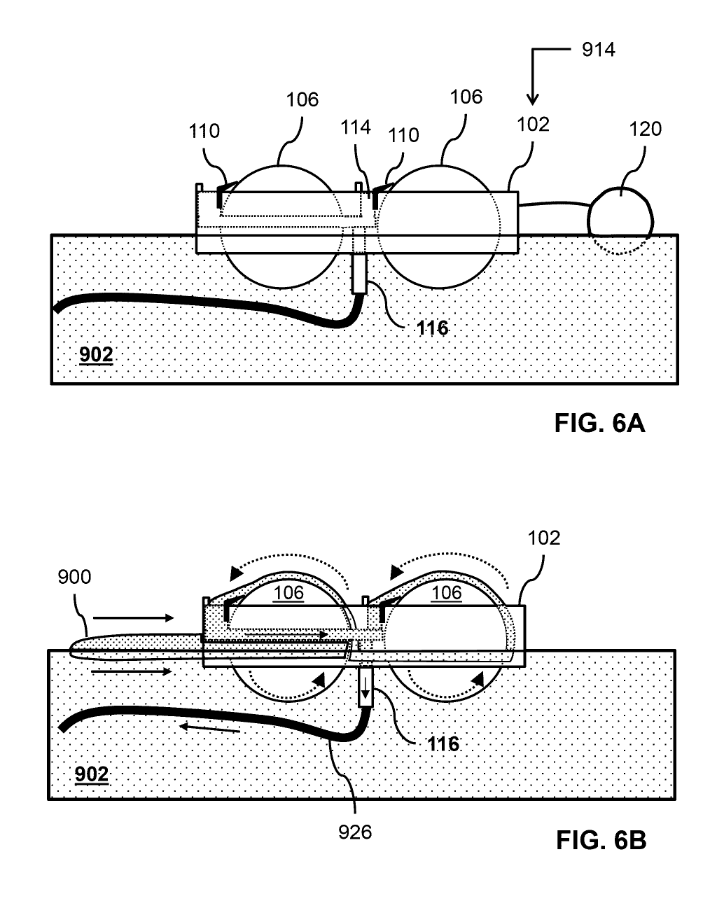

FIG. 6A and FIG. 6B depict side views of embodiments of the oil-slick skimmer system 914 of FIG. 2.

Referring to the embodiment as depicted in FIG. 6A, the elongated rotatable drum assembly 106 is placed on the water surface and supported by spaced-apart pontoon hulls 122 (as depicted in FIG. 2) to create a floating structure for floating on a body of water. The elongated rotatable drum assembly 106 may be fabricated from aluminum with a high density polyethylene sleeve slipped over the outside of the elongated rotatable drum assembly 106 to provide an oil adhering surface. The buoyant frame assembly 102 includes lateral sidebars (with the oil-collection container 114 positioned thereto), which are fastened to and suspended from the spaced-apart pontoon hulls 122. The elongated rotatable drum assembly 106 is mounted in the buoyant frame assembly 102. The elongated rotatable drum assembly 106 extends between the sidebars. One end of the drum shaft that extends through the elongated rotatable drum assembly 106 is supported by the coupler 118. The other end of the drum shaft is driven by a hydraulic motor 108. In operation, the elongated rotatable drum assembly 106 rotates depending on the thickness and viscosity of the oil to be skimmed. Hydraulic power is provided by the hydraulic control 930 through the control line 928.

In general terms, the oil-slick skimmer system 914 is configured to separate the oil slick 900 from the body of water 902. The oil-slick skimmer system 914 is deployed for oil-spill remediation and/or industrial applications. The oil-slick skimmer system 914 may include any one of (at least any one of) a weir-type oil skimmer, an oleophilic-type oil skimmer, a non-oleophilic type oil skimmer (disc, drum, belt, tube, brush, mop, grooved disc, grooved drum), etc.

The weir-type oil skimmer allows the oil slick floating on the surface of the water to flow over a weir. The oleophilic-type oil skimmer uses a rotating element such as a drum, to which the oil adheres. The oil is wiped from the surface of the drum and collected. They are very efficient and do not pick up any appreciable amounts of water even when oil is not present. The oleophilic skimmer may use ropes, discs, or drums that are treated with a substance or otherwise manufactured to adhere to the oil slick. The non-oleophilic disc oil skimmer includes a metal disc, belt or drum.

Referring to the embodiment as depicted in FIG. 6A, the oil-slick skimmer system 914 further includes a soaker pad assembly 120 that is coupled to the buoyant frame assembly 102 (by a line). The soaker pad assembly 120 is configured to pick up residue amounts of the oil slick 900 that the oil-slick skimmer system 914 does not pick up (if needed).

Referring to FIG. 6B, the oil-slick skimmer system 914 includes at least one or more instances of the elongated rotatable drum assembly 106, which rotates partly submerged in water. The oil attaches to the drum surface as the elongated rotatable drum assembly 106 rotates through the oil-water interface. The attached oil is then removed by squeezing or scraping the oil from the drum surface by using the wiper assembly 110. The oil-slick skimmer system 914 is placed on the water, and is held in the proper operating height by spaced-apart pontoon hulls 122. The elongated rotatable drum assembly 106 is rotated clockwise at the appropriate speed by the hydraulic motor 108 (FIG. 5). The elongated rotatable drum assembly 106 draws the oil layer on the top of the water, under and up over the elongated rotatable drum assembly 106, where the oil is removed by the wiper assembly 110 and flows into the oil-collection container 114. The oil travels from the oil-collection container 114 through the oil-conveying line 926 to the suction pump 932 (as depicted in FIG. 5), which provides suction and discharge of oil from the oil-slick skimmer system 914 to the oil-holding tank system 912 (in which the oil is now ready for processing). Treatment of the oil protects the environment, and preserves natural resources.

The oil-slick skimmer system 914 may include at least one or more instances of the elongated rotatable drum assembly 106 that are configured to pick up oil and deposit it in the oil-collection container 114. The oil-collection container 114 receives oil scraped from the elongated rotatable drum assembly 106.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for use with an oil slick suspended in a body of water, the apparatus comprising:
a rolling vehicle, including:
a vehicle frame; and
a lift system being supported by the vehicle frame; and
a hydraulic-control system being supported by the vehicle frame; and
an oil-holding tank system being supported by the vehicle frame, and the oil-holding tank system also being configured to receive a portion of the oil slick, and the oil-holding tank system being configured to apply suction for moving the oil slick into the oil-holding tank system; and
an oil-slick skimmer system being configured to:
be supported by the vehicle frame; and
be in fluid communication with the oil-holding tank system; and
be lifted and moved by the lift system onto the oil slick suspended in the body of water; and
be operated by the hydraulic-control system in such a way that the hydraulic-control system, in use, urges the oil-slick skimmer system to pick up the oil slick suspended in the body of water, and the oil-holding tank system moves the oil slick from the oil-slick skimmer system into the oil-holding tank system.

2. The apparatus of claim 1, wherein:
the oil-slick skimmer system includes:
a buoyant frame assembly having a lift connection being configured to be connected to the lift system in such a way that the lift system, in use, lifts the buoyant frame assembly; and
the buoyant frame assembly being configured to be buoyantly positioned in the oil slick suspended in the body of water once the buoyant frame assembly is positioned by the lift system to do just so.

3. The apparatus of claim 2, wherein:
the oil-slick skimmer system further includes:
an elongated rotatable drum assembly being rotatably supported by the buoyant frame assembly in such a way that rotation of the elongated rotatable drum assembly, in use, contacts the oil slick suspended on the body of water once the buoyant frame assembly is buoyantly positioned in the oil slick suspended in the body of water.

4. The apparatus of claim 3, wherein:
the oil-slick skimmer system further includes:
a hydraulic motor being operatively connected to a rotation axis of the elongated rotatable drum assembly, and the hydraulic motor being configured for fluid connection with the hydraulic-control system in such a way that the hydraulic-control system, in use, drives the hydraulic motor, and the hydraulic motor, in use, urges rotation of the elongated rotatable drum assembly, and in response to activation of the hydraulic motor, the rotation of the elongated rotatable drum assembly, in use, urges the elongated rotatable drum assembly to pick up the oil slick from the body of water once the buoyant frame assembly is buoyantly positioned in the oil slick suspended in the body of water.

5. The apparatus of claim 4, wherein:
the oil-slick skimmer system further includes:
a wiper assembly being supported by the buoyant frame assembly, and the wiper assembly extending toward an outer elongated surface of the elongated rotatable drum assembly in such a way that the wiper assembly, in use, wipes the oil slick from the outer elongated surface of the elongated rotatable drum assembly once the hydraulic motor, in use, urges rotation of the elongated rotatable drum assembly.

6. The apparatus of claim 5, wherein:
the oil-slick skimmer system further includes:
an oil-collection container being supported by the buoyant frame assembly, and the oil-collection container being configured to receive the oil slick that is removed by the wiper assembly.

7. The apparatus of claim 6, wherein:
the oil-slick skimmer system further includes:
a connection tube being configured to fluidly connect the oil-collection container to the oil-holding tank system in such a way that the oil slick moves from the oil-collection container via the connection tube to the oil-holding tank system in response to application of oil-moving suction to the connection tube.

8. The apparatus of claim 2, wherein:
the oil-slick skimmer system further includes:
a soaker pad assembly configured to be coupled to the buoyant frame assembly; and the soaker pad assembly configured to pick up residue amounts of the oil slick that the oil-slick skimmer system does not pick up.

9. The apparatus of claim 1, wherein:
the rolling vehicle also includes:
a washing station being configured to wash down any one of the rolling vehicle, the vehicle frame, the lift system, the hydraulic-control system, the oil-holding tank system and the oil-slick skimmer system.

10. The apparatus of claim 1, wherein:
the oil-slick skimmer system includes any one of a weir-type oil skimmer, an oleophilic-type oil skimmer and a non-oleophilic type oil skimmer.

11. The apparatus of claim 1, wherein:
the rolling vehicle includes:
a truck having a truck frame; and
a trailer having a trailer frame; and
a hitch connection being configured to operatively attached the truck frame to the trailer frame.

12. The apparatus of claim 11, wherein:
the truck frame of the truck is configured to support the lift system and the oil-slick skimmer system; and
the trailer frame of the trailer is configured to support the hydraulic-control system and the oil-holding tank system, with the oil-holding tank system positioned adjacent to the hydraulic-control system.

13. The apparatus of claim 11, wherein:
the oil-slick skimmer system includes:
a buoyant frame assembly having a lift connection being configured to be connected to the lift system in such a way that the lift system, in use, lifts the buoyant frame assembly; and
the buoyant frame assembly being configured to be buoyantly positioned in the oil slick suspended in the body of water once the buoyant frame assembly is positioned by the lift system to do just so; and
an elongated rotatable drum assembly being rotatably supported by the buoyant frame assembly in such a way that rotation of the elongated rotatable drum assembly, in use, contacts the oil slick suspended on the body of water once the buoyant frame assembly is buoyantly positioned in the oil slick suspended in the body of water; and
a hydraulic motor being operatively connected to a rotation axis of the elongated rotatable drum assembly, and the hydraulic motor being configured for fluid connection with the hydraulic-control system in such a way that the hydraulic-control system, in use, drives the hydraulic motor, and the hydraulic motor, in use, urges rotation of the elongated rotatable drum assembly, and in response to activation of the hydraulic motor, the rotation of the elongated rotatable drum assembly, in use, urges the elongated rotatable drum assembly to pick up the oil slick from the body of water once the buoyant frame assembly is buoyantly positioned in the oil slick suspended in the body of water; and
a wiper assembly being supported by the buoyant frame assembly, and the wiper assembly extending toward an outer elongated surface of the elongated rotatable drum assembly in such a way that the wiper assembly, in use, wipes the oil slick from the outer elongated surface of the elongated rotatable drum assembly once the hydraulic motor, in use, urges rotation of the elongated rotatable drum assembly; and
an oil-collection container being supported by the buoyant frame assembly, and the oil-collection container being configured to receive the oil slick that is removed by the wiper assembly; and
a connection tube being configured to fluidly connect the oil-collection container to the oil-holding tank system in such a way that the oil slick moves from the oil-collection container via the connection tube to the oil-holding tank system in response to application of oil-moving suction to the connection tube.

14. The apparatus of claim 13, wherein:
the truck frame of the truck is configured to support the lift system and the oil-slick skimmer system; and
the trailer frame of the trailer is configured to support the hydraulic-control system and the oil-holding tank system, with the oil-holding tank system positioned adjacent to the hydraulic-control system.

15. The apparatus of claim 14, wherein:
the oil-slick skimmer system further includes:
a soaker pad assembly configured to be coupled to the buoyant frame assembly; and the soaker pad assembly configured to pick up residue amounts of the oil slick that the oil-slick skimmer system does not pick up.

16. The apparatus of claim 15, wherein:
the rolling vehicle also includes:
a washing station being configured to wash down any one of the rolling vehicle, the vehicle frame, the lift system, the hydraulic-control system, the oil-holding tank system and the oil-slick skimmer system.
